(19) United States
(12) Patent Application Publication
(10) Pub. No.: US 2005/0140604 A1
(43) Pub. Date: Jun. 30, 2005

(54) Pixel circuit of display device and method for driving the same

(76) Inventor: Dong-Yong Shin, Seoul (KR)

Correspondence Address: CHRISTIE, PARKER & HALE, LLP, PO BOX 7068, PASADENA, CA, 91109-7068, US

(21) Appl. No.: 10/982,721

(22) Filed: Nov. 5, 2004

(30) Foreign Application Priority Data
Nov. 29, 2003 (KR) 2003-87794

(51) Int. Cl. G09G 3/30; G09G 3/10

(52) U.S. Cl. 345/76

(57) ABSTRACT

A pixel circuit of a display device for improving an opening ratio and a contrast ratio of emitting devices by sharing a driving circuit and sequentially emitting the emitting devices. A data charging period and an emitting period of the emitting devices are divided to prevent flow of wrong data current while data is being stored. The pixel circuit includes red, green, and blue emitting devices and a sequential controller sequentially controlling emission of the emitting devices for a certain sub-frame of a frame. A driving device is coupled to the emitting devices for transmitting driving signals to the emitting devices. A compensation circuit outputs voltage for compensating a threshold voltage of the driving device. The sequential controller controls the emitting devices so that the emitting devices are emitted only for a particular period of time of the subframe.

### CROSS-REFERENCE TO RELATED APPLICATION

This application claims priority to and the benefit of Korean Patent Application No. 2003-87794, filed on Nov. 29, 2003, the disclosure of which is hereby incorporated herein by reference in its entirety.

### BACKGROUND OF THE INVENTION

1. Field of the Invention

The present invention relates to a driving circuit of an emitting device used in an image display unit, and a method for driving the same. More particularly, the present invention relates to a pixel circuit of a display device for improving an opening ratio and a contrast ratio of the emitting device.

2. Description of Related Art

A display device, for example, an organic electroluminescent display device is a display device which generates a display by flowing current from a pixel electrode at each pixel to the organic electroluminescent device. The organic electroluminescent display device is generally divided into a passive matrix type organic electroluminescent display device and an active matrix type organic electroluminescent display device. The active matrix type organic electroluminescent display device generates an image display via switching devices in the pixels inside an organic pixel part, and applying voltage or current according to image data of the pixels.

FIG. 1 is a schematic diagram of a conventional active matrix type organic electroluminescent display device according to the prior art.

As illustrated in FIG. 1, the active matrix type organic electroluminescent display device includes data driver 10 for outputting image data, scan driver 20 for outputting scan signals, and pixel part 30 in which data lines D1, D2, . . . . Dm-1, Dm and gate lines S1, S2, . . . . Sm-1, Sm respectively connected from the data driver 10 and scan driver 20 are longitudinally and laterally arranged. Each of the pixels 40 according to this embodiment are a combination of red, green, and blue unit pixels 41 respectively formed at a crossing portion of gate lines and data lines in the pixel part 30.

The pixels 40 display respective colors according to a combination of red, green, and blue unit colors as unit pixel circuits 41 transmit corresponding driving signals to respective emitting devices according to applied signals when image data is applied to the unit pixel circuits from the data driver 10, and scan signals are applied to the unit pixel circuits from the scan driver 20. That is, conventional pixels 40 include driving circuits respectively formed at the unit pixels and connected to the gate lines S1, S2, . . . , Sm-1, Sm and data lines D1, D2, D3, . . . , Dm so that each pixel data is displayed by individually driving the respective unit pixels P(R,G,B)11-P(R,G,B)mn according to input scan signals and data signals.

The unit pixels P(R,G,B)11-P(R,G,B)mn for displaying certain colors include compensation circuits for solving a deviation of signals according to circuit component characteristics. The compensation circuits of the unit pixels include self compensation circuits for compensating a threshold voltage of a driving switching device by connecting the driving switching device to a diode, and non-self compensation circuits equipped with a separate compensation switching device to compensate a threshold voltage of the driving switching device.

FIG. 2 is a schematic diagram of a non-self compensation pixel circuit in a conventional display device according to the prior art.

Conventional pixels include unit pixels 41a, 41b, 41c where the unit pixels 41a, 41b, 41c respectively include non-self compensation circuits 42, 43, 44 respectively connected to data lines 11, 12, 13 and gate line 21 to compensate for a threshold voltage of a driving transistor. The unit pixels 41a, 41b, 41c also respectively include capacitors C1, C2, C3 connected to the non-self compensation circuits 42, 43, 44 to store data, and thin film transistors M1, M2, M3 having gates respectively connected to non-self compensation circuits 42, 43, 44, having sources connected to their respective power supply voltages, and having drains respectively connected to emitting devices R, G, B. A red electroluminescence (EL) device R is included in unit pixel 41a, green EL device G is included in unit pixel 41b, and blue EL device B is included in unit pixel 41c.

Switching transistors (not shown) included in the non-self compensation circuits 42, 43, 44 are switched on by scan signals for transmitting data signals if the data signals are applied through the data lines 11, 12, 13 and scan signals are sequentially applied to the unit pixels 41a, 41b, 41c through the gate line 21. The transmitted data signals are respectively stored in the capacitors C1, C2, C3 so that the data signals stored in the capacitors C1, C2, C3 may be applied to the thin film transistors M1, M2, M3. The thin film transistors M1, M2, M3 transmit driving signals corresponding to the data signals stored in the capacitors C1, C2, C3 to the respective emitting devices R, G, B connected to the thin film transistors M1, M2, M3. The non-self compensation circuits 42, 43, 44 output compensation voltages corresponding to threshold voltages of the thin film transistors M1, M2, M3 so that the thin film transistors M1, M2, M3 output driving signals of the emitting devices R, G, B that correspond to the original data.

The unit pixels 41a, 41b, 41c concurrently cause red, green and blue EL devices R, G, B to emit according to the scan signals and data signals so that the pixels 40 may display certain colors.

FIG. 3 is a schematic diagram of self compensation circuits in a conventional display device according to the prior art.

Pixels 40′ in FIG. 3 include unit pixels 41d, 41e, 41f which are arranged at a crossing portion where data lines 14, 15, 16 and gate line 22 longitudinally and laterally cross each other so that the unit pixels 41d, 41e, 41f are respectively connected to the data lines 14, 15, 16 and the gate line 22. Unit pixel 41d includes self compensation circuit 48 connected to data line 14 and gate line 22. Unit pixel 41d further includes capacitor C1 and thin film transistor M1 connected to self compensation circuit 48 and to red EL device R via a drain of thin film transistor M1. Thin film transistor M4 is arranged between the drain of thin film transistor M1 and red EL device R so that thin film transistor M4 is connected to emission control line 51.

Unit pixel 41e includes self compensation circuit 49 connected to data line 15 and gate line 22. Unit pixel 41e further includes capacitor C2 and thin film transistor M2 connected to self compensation circuit 49 and to green EL device G via a drain of thin film transistor M2. Thin film transistor M5 is arranged between the drain of thin film transistor M2 and green EL device G so that thin film transistor M5 is connected to the emission control line 51.

Unit pixel 41f includes self compensation circuit 50 connected to data line 16 and gate line 22. Unit pixel 41f further includes capacitor C3 and thin film transistor M3 connected to self compensation circuit 50 and to blue EL device B via a drain of thin film transistor M3. Thin film transistor M6 is arranged between the drain of thin film transistor M3 and blue EL device B so that thin film transistor M6 is connected to the emission control line 51.

Thin film transistors M1, M2, M3 are switched on to transmit the data signals transmitted through data lines 14, 15, 16 to capacitors C1, C2, C3 if data signals are applied to data lines 14, 15, 16, and scan signals are sequentially applied to unit pixels 41d, 41e, 41f through the gate line 22.

Thin film transistors M4, M5, M6 prevent driving signals output from thin film transistors M1, M2, M3 from applying to EL devices R, G, B during a data charging period responsive to off signals transmitted through the emission control line 51 connected to thin film transistors M4, M5, M6 during the data charging period when data signals are stored in capacitors C1, C2, C3.

When the data charging period has expired, the data signals are transmitted from capacitors C1, C2, C3 to thin film transistors M1, M2, M3. Thin film transistors M4, M5, M6 apply driving signals output from thin film transistors M1, M2, M3 to EL devices R, G, B according to on signals transmitted through the emission control line 51 connected to thin film transistors M4, M5, M6. Thin film transistors M1, M2, M3 output driving currents corresponding to data signals applied to the red, green and blue EL devices R, G, B. Accordingly, the red, green and blue EL devices R, G, B are concurrently emitted so that a pixel 40 displays a certain color.

FIG. 4 is a timing graph of a pixel driving method in a conventional display device according to the prior art.

First, when scan signal S1 is applied to gate line S1, gate line S1 is driven, and pixels PR11-PB1n connected to gate line S1 are driven.

That is, switching thin film transistors included in the compensation circuits of respective red, green and blue unit pixels PR11-PR1n, PG11-PG1n, PB11-PB1n connected to gate line S1 are driven by the scan signal S1 applied to gate line S1. According to the driving of the switching thin film transistors, red, green and blue data signals D1(DR1-DRn), D1(DG1-DGn), D1(DB1-DBn) are concurrently applied to the gates of the driving thin film transistors M1, M2, M3 of red, green and blue unit pixels from red, green and blue data lines DR1-DRn, DG1-DGn, DB1-DBn including m data lines D1, . . . , Dm.

The driving thin film transistors M1, M2, M3 of the red, green and blue unit pixels supply driving currents corresponding to the red, green and blue data signals D1 (DR1-DRn), D1 (DG1-DGn), D1 (DB1-DBn) respectively applied to the red, green and blue data lines DR1-DRn, DG1-DGn, DB1-DBn to the red, green and blue EL devices R, G, B. Therefore, EL devices including pixels PR11-PB1n connected to gate line S1 are concurrently driven if scan signal is applied to gate line S1.

In the same way, if scan signal S2 for driving gate line S2 is applied to gate line S2, data signals D2(DR1-DRn), D2(DG1-DGn), D2(DB1-DBn) are applied to pixels PR21-PR2n, PG21-PG2n, PB21-PB2n connected to gate line S2 from the red, green and blue data lines DR1-DRn, DG1-DGn, DB1-DBn.

EL devices including pixels PR21-PR2n, PG21-PG2n, PB21-PB2n connected to gate line S2 are concurrently driven by driving current corresponding to data signals D2(DR1-DRn), D2(DG1-DGn), D2(DB1-DBn).

Lastly, if scan signal Sm is applied to gate line Sm by repeating the above described actions, EL devices including pixels PRm1-PBmn connected to gate line Sm are concurrently driven according to red, green and blue data signals Dm(DR1-DRn), Dm(DG1-DGn), Dm(DB1-DBn) applied to red, green and blue data lines DR1-DRn, DG1-DGn, DB1-DBn.

Therefore, if scan signals are sequentially applied to gate line Sm from gate line S1, pixels (PR11-PB1n)-(PRm1-PBmn) connected to the respective gate lines S1-Sm are sequentially driven to display an image by driving the pixels during a particular frame.

One drawback with the above-described method for driving a display drive is that three data lines and three power supply lines are arranged at each pixel, and multiple thin film transistors and compensation circuits and capacitors are required in the pixel circuit of the display device. With respect to the self compensation circuits (FIG. 3), a problem is that the structure of their circuits is complicated, and yield is deteriorated since a separate emission control line for providing emission control signals is generally required. The prior art circuits also have to be generally constructed in a limited space allotted to the pixel part.

Furthermore, the prior art has problems that the area of the pixels is decreased as a display device gets more elaborate, making it difficult to arrange many elements in one pixel. An opening ratio is therefore decreased accordingly.

### SUMMARY OF THE INVENTION

According to one embodiment of the present invention, a pixel circuit of an organic electroluminescent display device and method for driving the same is provided that is appropriate for high density and precision, and capable of improving opening ratio and yield.

According to another embodiment of the present invention, a pixel circuit of an organic electroluminescent display device and method for driving the same is provided in which pixel circuits are simply constructed and capable of being used in both self compensation circuits and non-self compensation circuits.

According to another embodiment of the present invention, a pixel circuit of an organic electroluminescent display device and method for driving the same is provided that is capable of expressing black gradation and improving contrast ratio by driving red, green and blue emitting devices per data charging period and emitting period.

According to one embodiment, the present invention is directed to a pixel circuit of a display device including at least two emitting devices and a sequential controller sequentially controlling emission of the at least two emitting devices for a certain period of time in a certain section. A driving device is coupled to the at least two emitting devices for transmitting driving signals to the at least two emitting devices. A compensation circuit outputs voltage for compensating a threshold voltage associated with the driving device. The sequential controller controls the at least two emitting devices so that the at least two emitting devices are emitted only for a particular time period during the certain period of time.

The sequential controller sequentially controls the at least two emitting devices by dividing the certain period of time into a data charging period and an emitting period in such a way that the emitting devices are driven only during the emitting period so as to generate a certain color.

According to one embodiment, the certain section is a single frame, the certain period of time is a time period of a sub-frame of the single frame, the single frame is divided into at least two sub-frames, and one or more emitting devices are sequentially driven during their respective sub-frames.

According to another embodiment, the certain section is a single frame, the certain period of time is a time period of a sub-frame of the single frame, the single frame is divided into at least three sub-frames, two or more emitting devices are sequentially driven during their respecitve sub-frames of the single frame, and one of the two or more of the emitting devices is driven again in at least one remaining sub-frame, or at least two of the two or more emitting devices are concurrently driven in at least one remaining sub-frame.

According to one embodiment, the at least one remaining sub-frame is arbitrarily selected from a plurality of sub-frames.

The emitting devices may be field emission display (FED) devices, organic electroluminescence (EL) devices, or liquid crystal display (LCD) devices.

According to one embodiment, the sequential controller includes a first electrode coupled to the driving device, and a second electrode connected to one of the at least two emitting devices.

According to one embodiment, the sequential controller also includes at least one switching device.

According to another embodiment, the present invention is directed to a pixel circuit of a display device including red, green and blue EL devices. A driving device coupled to the red, green and blue EL devices transmit driving signals to the red, green and blue EL devices. A sequential controller coupled to the red, green and blue EL devices sequentially controls emission of the red, green and blue EL devices for a certain period of time in a certain section. A sequential control part transmits switching signals to the sequential controller for the certain period of time in the certain section. The sequential controller controls emission of any one of the red, green and blue EL devices for the certain period of time in the certain section associated with a data charging period and an emission period.

The sequential controller sequentially controls at least two of the red, green and blue EL devices in such a way that the EL devices are driven only during the emission period by dividing the certain period of time in the certain section into the data charging period and the emission period.

According to one embodiment, the certain section is a single frame, the certain period of time is a time period of a sub-frame of the single frame, the single frame is divided into at least two sub-frames, and one or more of the red, green and blue EL devices are sequentially driven during their respective sub-frames.

According to another embodiment, the certain section is a single frame, the certain period of time is associated with a sub-frame, the single frame is divided into at least three sub-frames, two or more of the red, green and blue EL devices are sequentially driven during their respective sub-frames of the single frame, and one of the two or more of the EL devices are driven again in at least one remaining sub-frame, or at least two of the two or more EL devices are concurrently driven in the at least one remaining sub-frame.

The at least one remaining sub-frame may be arbitrarily selected from a plurality of sub-frames.

According to another embodiment, the present invention is directed to a method for driving a pixel circuit of a display device associated with a plurality of gate lines and a plurality of data lines. The method includes sequentially applying scan signals via the gate lines and sequentially applying one or more of the data signals through the data lines, the scan and data signals being concurrently applied during a certain period of time in a certain section. An off signal is applied to a sequential controller for blocking flow of the data signals to electroluminescance (EL) devices during storing of the data signals. An on signal is applied to the sequential conroller associated with the data signals for causing emission of the EL devices responsive to the data signals being stored.

According to one embodiment, the certain section is a single frame, the certain period of time is a time period of a sub-frame of the single frame, the single frame is divided into at least two of sub-frames, and one or more of the EL devices are sequentially driven during their respective sub-frames.

According to another embodiment, the certain section is a single frame, the certain period of time is a time period of a sub-frame of the single frame, the single frame is divided into at least three sub-frames, at least two of the red, green and blue EL devices are sequentially driven during their respective subframes of the single frame, and one of the two or more of the EL devices are driven again in at least one remaining sub-frame, or at least two of the two or more EL devices are concurrently driven in the at least one remaining subframe.

The at least one remaining sub-frame is arbitrarily selected from a plurality of sub-frames.

According to another embodiment, the present invention is directed to a flat panel display having a pixel circuit described according to any of the above-embodiments.

### BRIEF DESCRIPTION OF THE DRAWINGS

The above and other features and advantages of the present invention will become more apparent to those of ordinary skill in the art via a description of exemplary embodiments and with reference to the attached drawings in which:

FIG. 1 is a block diagram of a conventional display device according to the prior art;

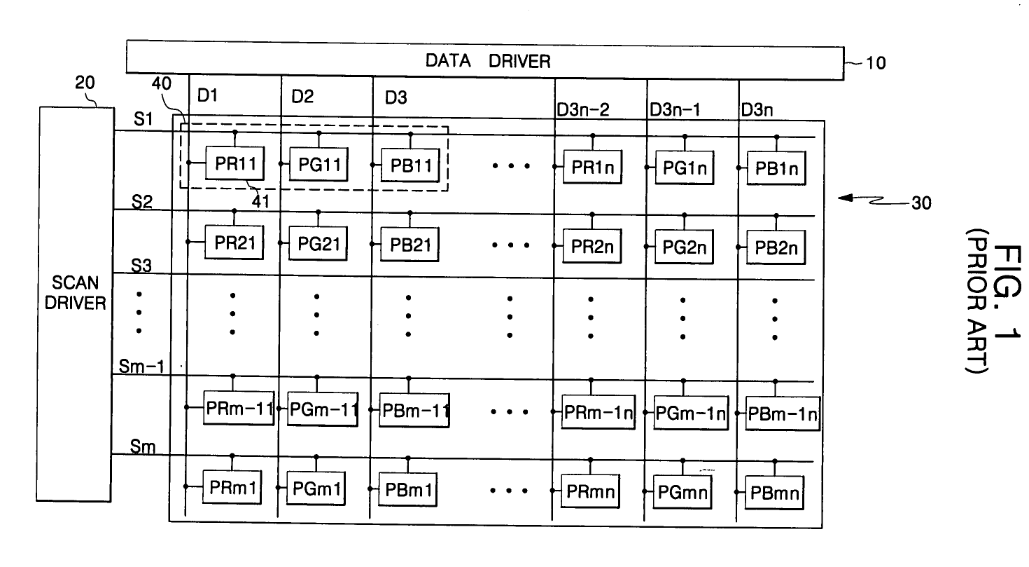

FIG. 2 is a schematic diagram of non-self compensation circuits in a conventional display device according to the prior art;

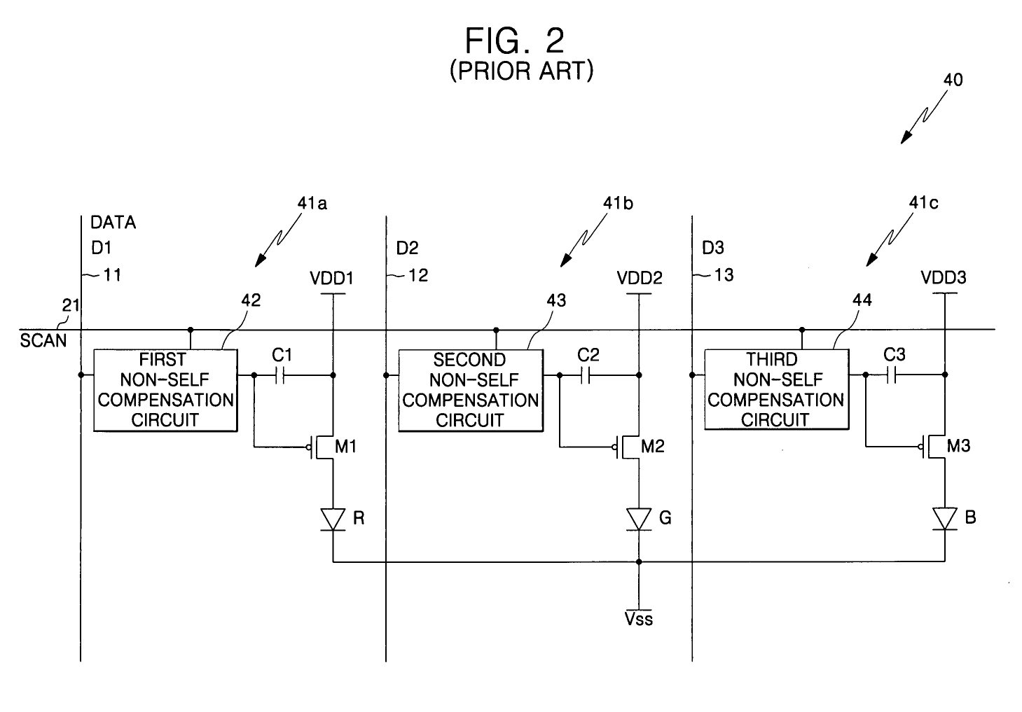

FIG. 3 is a schematic diagram of self compensation circuits in a conventional display device according to the prior art;

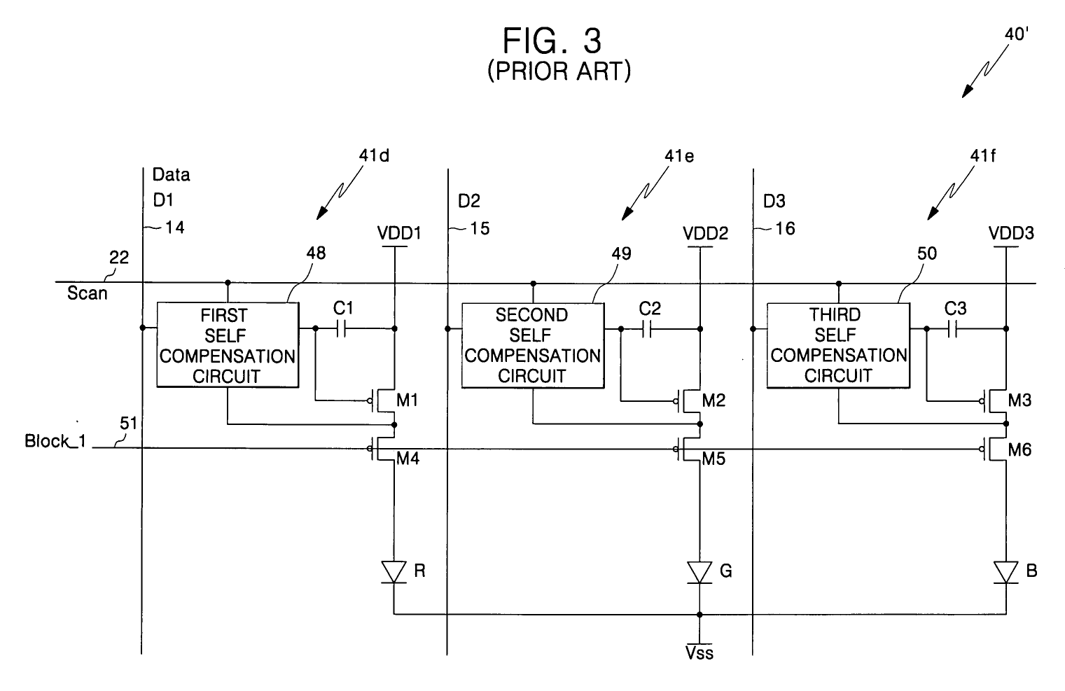

FIG. 4 is a timing graph of a pixel driving method in a conventional display device according to the prior art;

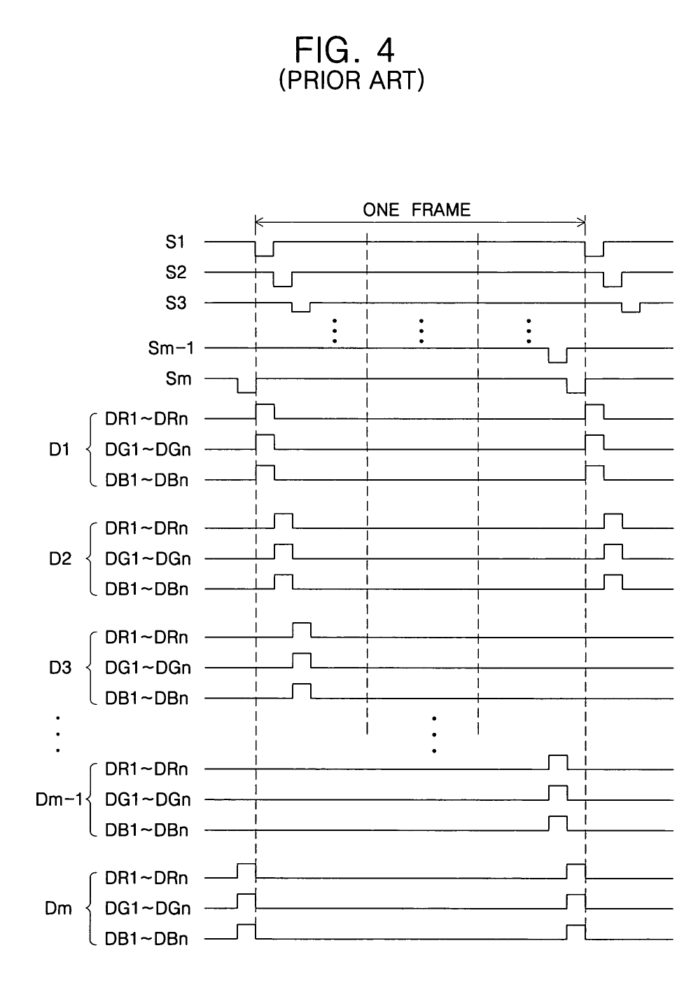

FIG. 5 is a block diagram of a display device according to an exemplary embodiment of the present invention;

FIG. 6 is a schematic diagram illustrating a pixel circuit of a display device according to one embodiment of the present invention; and

FIG. 7 is a timing graph of a pixel driving method of a display device according to one embodiment of the present invention.

The following is an explanation of some of the reference numbers in the drawings:
100: data driver
200: scan driver
300: sequential control part
311R: red emission control line
311G: green emitting control line
311B: blue emission control line
400: pixel part
410: pixel
420: compensation circuit
431: first sequential controller
432: second sequential controller
433: third sequential controller

### DETAILED DESCRIPTION

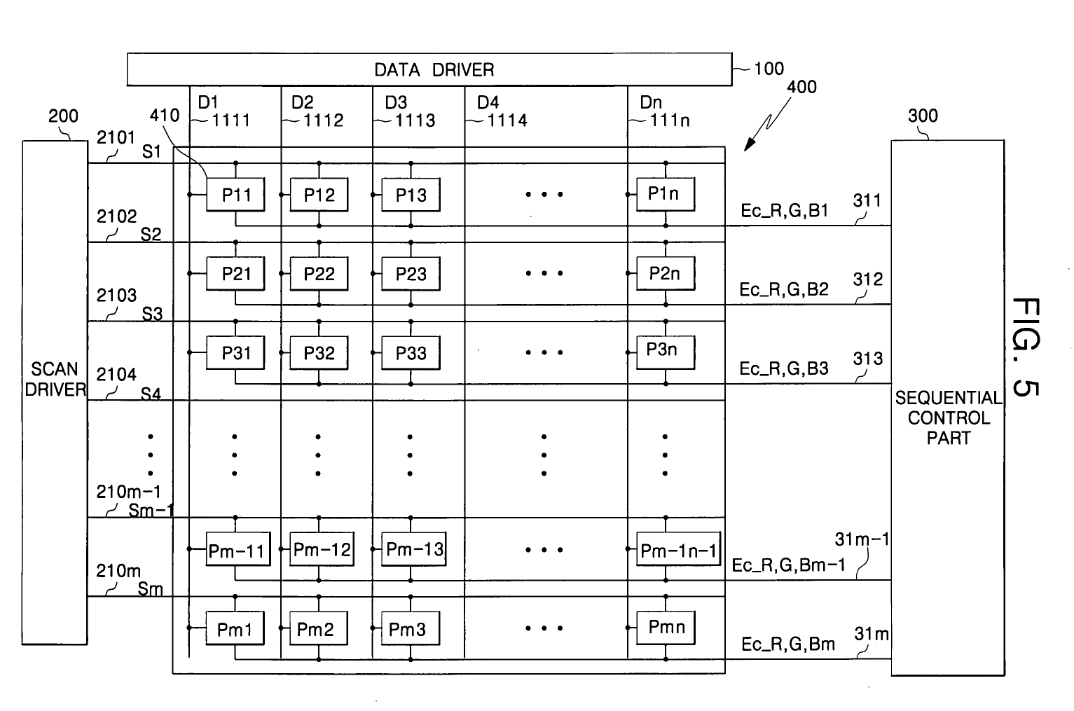

FIG. 5 is a block diagram of an organic electroluminescent display device according to an exemplary embodiment of the present invention.

The organic electroluminescent display device illustrated in FIG. 5 includes data driver 100, scan driver 200, sequential control part 300 and pixel part 400. Pixel part 400 includes a plurality of gate lines 2101-210n to which scan signals S1-Sm are supplied from the scan driver 200, a plurality of data lines 1111-111n to which data signals D1-Dm are supplied from the data driver 100, and a plurality of emission control lines 311-31m to which emission control signals EC_R,G,B1-EC_R,G,Bm are supplied from the sequential control part 300.

The pixel part 400 further includes a plurality of pixels P11-Pmn arranged in a matrix shape and connected to their respective gate lines 2101-210m, data lines 1111-111n, and emission control lines 311-31m.

According to the illustrated embodiment, pixel P11 is connected to gate line 2101 for providing scan signal S1, to data line 1111 for providing data signal D1, and to emission control line 311 for outputting a first emission control signal EC_R, G, B1.

In this manner, scan signals S1, S2, S3, . . . , Sm are applied to the respective pixels P11-Pmn through corresponding gate lines 2101-210m, red, green and blue data signals DR1-DRm, DG1-DGm, DB1-DBm are sequentially transmitted to the pixels P11-Pmn through corresponding data lines 1111-111n, and corresponding red, green and blue emission control signals EC_R, G, B are sequentially transmitted to pixels P11-Pmn through corresponding emission control lines 311-31m. Therefore, whenever corresponding scan signals S1-Sm are applied to respective pixels P11-Pmn, corresponding red, green and blue data signals DR1-DRm, DG1-DGm, DB1-DBm are sequentially transmitted to pixels P11-Pmn, and red, green and blue EL devices R′, G′, B′ are sequentially driven according to the red, green and blue emission control signals EC_R, G, B to sequentially emit lights corresponding to the red, green and blue data signals DR1-DRm, DG1-DGm, DB1-DBm.

The sequential control part 300 outputs emission control signals EC_R, G, B to pixels P1-Pmn so that the sub-frames are sequentially driven to display a certain color, that is, to display an image during a frame by dividing the frame into, for example, three sub-frames and dividing each of the sub-frames into a data charging section in which the data signals DR1-DRm, DG1-DGm, DB1-DBm are stored and associating in emission period during which the red, green and blue EL devices R′, G′, B′ included in pixels P11-Pmn are emitted.

For example, one frame is divided into three or more of sub-frames so that respective emitting devices R′, G′, B′ are sequentially driven for each of the sub-frames within the frame. According to this example, either one device out of the emitting devices R′, G′, B′ is driven, or at least two emitting devices are concurrently driven in at least one remaining sub-frame so as to control brightness. The at least one remaining sub-frame is arbitrarily selected from a plurality of sub-frames.

Although the emitting devices are described as an example of an organic (EL) device in one embodiment of the present invention, any one of field emission display (FED), liquid crystal display (LCD), or organic EL devices may be adopted in other embodiments of the invention.

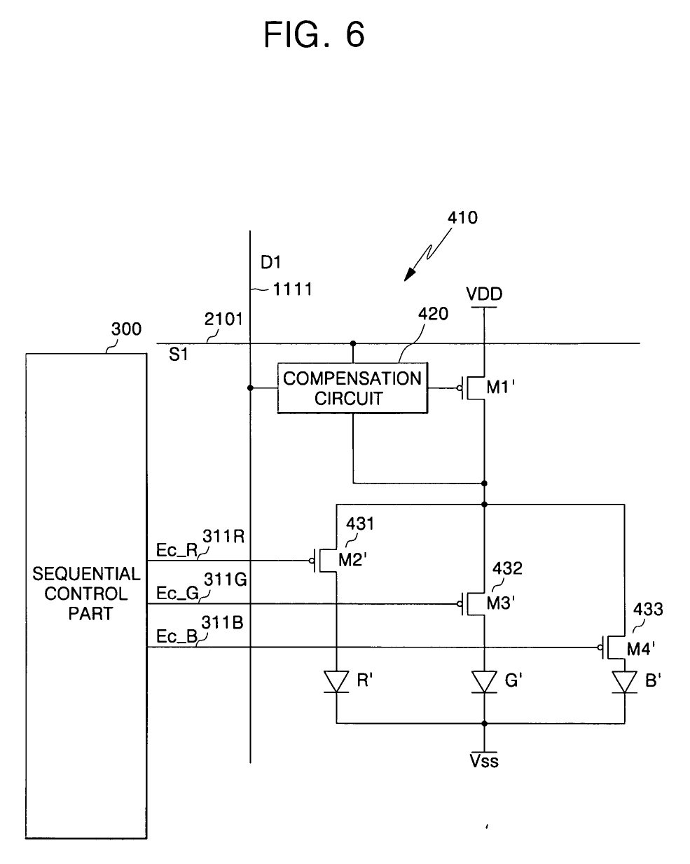

FIG. 6 is a schematic diagram of a pixel circuit of pixel 410 of a display device according to one embodiment of the present invention.

The illustrated pixel 410 includes a compensation circuit 420 including data line 1111 to which a source of data is connected, gate line 2101 to which a gate is connected, and capacitor (not shown) for storing a data signal transmitted from data line 1111. The pixel 410 further includes a thin film transistor M1′ connected to compensation circuit 420 to output a driving signal corresponding to the data signal, and sequential controllers 431, 432, 433 commonly connected to thin film transistor M1″. A red EL device R′ is connected to sequential controller 431, green EL device G′ is connected to sequential controller 432, and blue EL device B′ is connected to the sequential controller 433. The compensation circuit 420 includes self compensation circuits or non-self compensation circuits. That is, either the self compensation circuits or non-self compensation circuits may be applied to the display device according to one embodiment of the present invention.

According to one embodiment, each pixel 410 in the display device of FIG. 5 includes unit pixels in such a manner that red, green and blue EL devices R′, G′, B′ included in each unit pixel are commonly connected to driving device M1′, and red, green and blue EL devices R′, G′, B′ are sequentially controlled through their respective sequential controllers 431, 432, 433.

The sequential controllers 431, 432, 433 divide a particular frame for displaying an image in the pixel 410, into at least two or more, or at least three or more, sub-frames. The divided sub-frames are driven during each data charging period and emission period.

In other words, if a switching thin film transistor (not shown) included in the compensation circuit 420 is turned on according to a scan signal transmitted through gate line 2101, red, green and blue data DR1-DRm, DG1-DGm, DB1-DBm transmitted through data line 1111 is stored in a capacitor (not shown) included in the compensation circuit 420.

Compensation circuit 420 outputs a voltage corresponding to a threshold voltage of thin film transistor M1′ to the capacitor. Therefore, the data signal and a compensation voltage for compensating the threshold voltage of thin film transistor M1′ are stored in the capacitor.

The sequential control part 300 outputs respective emission control signals EC_R, G, B to sequential controllers 431, 432, 433 so that the respective emission control signals EC_R, G, B are turned off during a data charging period when data is stored in the capacitor. The sequential controllers 431, 432, 433 are turned off to prevent driving signals from being applied to the respective emitting devices R′, G′, B′ during the data charging period. That is, a particular frame for displaying an image on the display device is divided into a plurality of sub-frames. At least one or more of the emitting devices are sequentially emitted per sub-frame, and the sub-frames are divided into a data charging period and an emission period. Transmission of the driving signals to the respective emission devices is blocked during the data charging period according to emission control of the sequential controllers 431, 432, 433, and data of emitting devices R′ G′ B′ is stored in the capacitor.

Afterwards, if the data charging period has expired, the sequential control part 300 outputs an on signal to any one of the sequential controllers 431, 432, 433. In response, the data signal stored in the capacitor is transmitted to thin film transistor M1′ and thin film transistor M1′ outputs a driving signal corresponding to an applied data signal to start the emission period.

At least any one or more of emitting devices of the red, green and blue EL devices R′, G′, B′ are sequentially emitted in the respective sub-frames of a frame in such a way that at least any one or more of the emitting devices are turned off during a data charging period when the sequential controllers 431, 432, 433 are turned off, and the emitting devices are emitted during an emission period when the sequential controllers 431, 432, 433 are turned on.

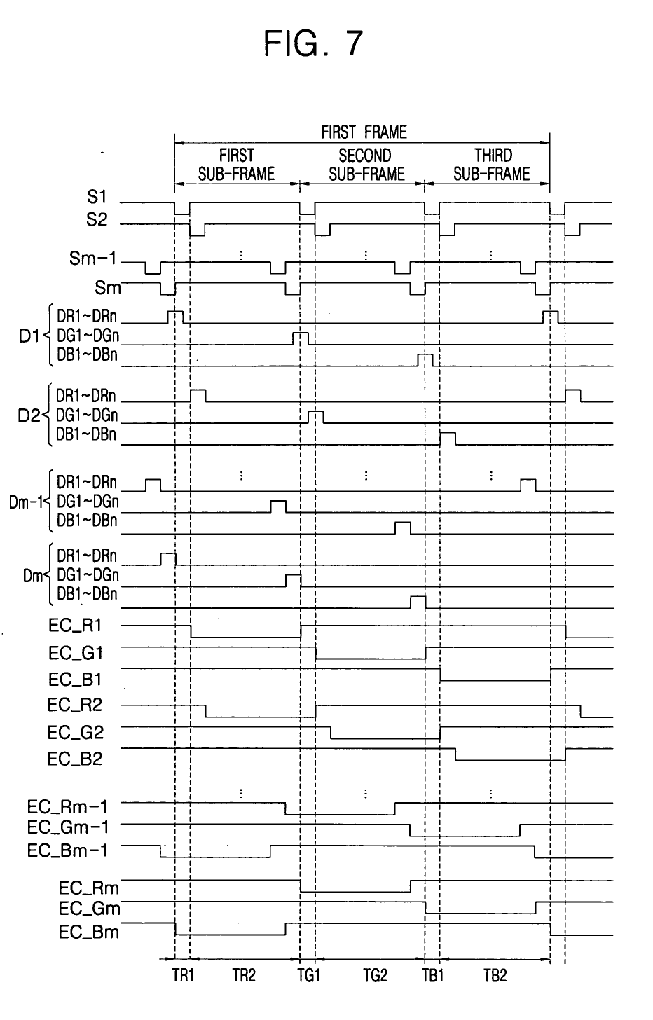

FIG. 7 is a timing graph of a pixel driving method of a display device according to one embodiment of the present invention.

First, if scan signal S1 is applied to gate line 2101 from scan driver 200 during a first sub-frame of a frame, gate line 2101 is driven, and red data signals DR1-DRn transmitted from data driver 100 as data signals D1-Dm are stored in a capacitor in pixels P11-P1n. Additionally, sequential control part 300 impresses off control signals to red, green and blue EL devices R′, G′, B′ of pixels P11-P1n connected to gate line 2101 through a red emission control line 311R so that sequential controllers 431, 432, 433 are turned off during a data charging period when the data signals DR1-DRn are stored in the capacitor. Therefore, red, green and blue EL devices R′, G′, B′ connected to sequential controllers 431, 432, 433 are turned off during a data charging period TR1 since sequential controllers 431, 432, 433 are turned off according to emission control signals EC_R1, EC_G1, EC_B1 applied to sequential controllers 431, 432, 433.

After a certain period of time, the sequential control part 300 outputs emission control signal EC_R1 to sequential controller 431 so that sequential controller 431 is turned on, data charging period TR1 is completed, and emission period TR2 is initiated. The sequential control part 300 impresses off emission control signals EC_G1, EC_B1 to sequential controllers 432, 433 so that the green and blue EL devices G′, B′ are turned off during the first sub-frame.

Red data DR1-DRn stored in the capacitor is transmitted to thin film transistor M1′ which is a driving device, and thin film transistor M1′ transmits a driving current corresponding to the red data DR1-DRn to the red EL device R′ through sequential controller 431 so that the red EL device R′ is emitted during emission period TR2.

If second scan signal S1 is applied to gate line 2101 during a second sub-frame of the first frame, a data charging period TG1 of the second sub-frame is started for storing green data signals DG1-DGn in the capacitor through the compensation circuit 420 by data lines 1111-111n. Red, green and blue EL devices R′, G′, B′ are turned off during data charging period TG1 since off control signals are applied to sequential controllers 431, 432, 433 of pixels P11-P1n connected to gate line 2101 through red, green and blue emission control lines 311R, 311G, 311B from the sequential control part 300.

After a certain period of time the sequential control part 300 outputs emission control signal EC_G1 to sequential controller 432 so that sequential controller 432 is turned on to complete data charging period TG1 and initiate emission period TG2. The sequential control part 300 impresses off emission control signals EC_R1, EC_B1 to sequential controllers 431, 433 so that the red and blue EL devices R′, B′ are turned off during the second sub-frame.

Green data DG1-DGn stored in the capacitor is transmitted to thin film transistor M1′ which is a driving device, and thin film transistor M1′ transmits a driving current corresponding to the green data DG1-DGn to the green EL device G′ through the sequential controller 432 so that the green EL device G′ is emitted during emission period TG2 accordingly.

If third scan signal S1 is applied to gate line 2101 during a third sub-frame of the first frame, a data charging period TB1 of the third sub-frame is started for storing blue data signals DB1-DBn in the capacitor through thin film transistor M1′ by data lines 1111-111n. Red, green, and blue EL devices R′, G′, B′ are turned off during data charging period TB1 since off control signals are applied to sequential controllers 431, 432, 433 of pixels P11-P1n connected to gate line 2101 through red, green, and blue emission control lines 311R, 311G, 311B from the sequential control part 300.

After a certain period of time, the sequential control part 300 outputs emission control signal EC_B1 to sequential controller 433 so that sequential controller 433 is turned on to complete data charging period TB1 and initiate emission period TB2. The sequential control part 300 impresses off emission control signals EC_R1, EC_G1 to the sequential controllers 431, 432 so that the red and green EL devices R′, G′ are turned off during the third sub-frame.

Blue data DB1-DBn stored in the capacitor is transmitted to thin film transistor M2′, and thin film transistor M2′ transmits a driving current corresponding to the blue data DB1-DBn to the blue EL device B′ through sequential controller 433 so that the blue EL device B′ is emitted during emission period TB2 accordingly.

Subsequently, if scan signal S2 is applied to gate line 2102 for each sub-frame of a frame, red, green and blue data signals DR1-DRn, DG1-DGn, DB1-DBn are sequentially applied to data lines 1111-111n, and emission control signals EC_R2, EC_G2, EC_B2 for sequentially controlling red, green and blue EL devices R′, G′, B′ of pixels P21-P2n connected to gate line 2102 through emission control lines 311R, 311G, 311B from the sequential control part 300 during data charging periods TR1, TG1, TB1 and emission periods TR2, TG2, TB2 are sequentially transmitted to sequential controllers 431, 432, 433. Therefore, the respective sequential controllers 431, 432, 433 are sequentially turned on to sequentially transmit driving current corresponding to the red, green and blue data signals DR1-DRn, DG1-DGn, DB1-DBn to the red, green and blue EL devices R′, G′, B′ so that the red, green and blue EL devices R′, G′, B′ are driven.

If scan signal is applied to m gate lines 2101-210m per sub-frame of a frame by repeating the foregoing action, red, green and blue data signals DR1 DRn, DG1-DGn, DB1-DBn are sequentially applied to data lines 1111-111n, and emission control signals EC_Rm, EC_Gm, EC_Bm for sequentially controlling red, green and blue EL devices R′, G′, B′ of pixels Pm1-Pmn connected to the m gate lines 2101-210m through emission control lines 311R, 311G, 311B from the sequential control part 300 are sequentially generated to the sequential control part 300 by dividing the red, green and blue EL devices R′, G′, B′ into sub-frames during data charging period TR1, TG1, TB1 and emission period TR2, TG2, TB2. Accordingly, sequential controllers 431, 432, 433 are turned on to sequentially transmit driving current corresponding to the red, green and blue data signals DR1-DRn, DG1-DGn, DB1-DBn to the red, green and blue EL devices R′, G′, B′ so that the red, green and blue EL devices R′, G′, B′ are driven.

Therefore, according to one embodiment, one frame is divided into three sub-frames, and the red, green and blue EL devices R′, G′, B′ are sequentially driven during the three sub-frames to display an image. The image is displayed as if the red, green and blue EL devices R′, G′, B′ were concurrently driven for a normal display of images since the red, green and blue EL devices R′, G′, B′ are sequentially driven very fast.

One embodiment of the present invention enables high density and precision to be obtained since red, green and blue emitting devices are driven in a time-divided manner by sharing a driving device and a switching device. The opening ratio and yield are also improved via a reduction of the number of devices and wirings by enabling the red, green and blue emitting devices to be commonly applied to self compensation and non-self compensation circuits. Additionally, one embodiment of the present invention allows the display of black gradation and improves contrast ratio by driving the red, green and blue emitting devices which are divided per data charging period and emission period.

While the invention has been described with reference to certain exemplary embodiments, it will be understood by those skilled in the art that the invention is intended to cover various changes in form and details without departing from the spirit and scope of the invention. Of course, the scope of the invention is to be determined by the appended claims and equivalents thereof.

1. A pixel circuit of a display device comprising:
at least two emitting devices;
a sequential controller for sequentially controlling emission of the at least two emitting devices for a certain period of time in a certain section;
a driving device coupled to the at least two emitting devices for transmitting driving signals to the at least two emitting devices; and
a compensation circuit for outputting voltage for compensating a threshold voltage of the driving device,
wherein, the sequential controller controls the at least two emitting devices so that the at least two emitting devices are emitted only for a particular time period during the certain period of time.

2. The pixel circuit of a display device according to claim 1, wherein the sequential controller sequentially controls the at least two emitting devices by dividing the certain period of time into a data charging period and an emitting period, wherein the emitting devices are driven only during the emitting period.

3. The pixel circuit of a display device according to claim 2, wherein the certain section is a single frame, the certain period of time is a time period of a sub-frame of the single frame, the single frame is divided into at least two sub-frames, and one or more emitting devices are sequentially driven during their respective sub-frames.

4. The pixel circuit of a display device according to claim 2, wherein the certain section is a single frame, the certain period of time is a time period of a sub-frame of the single frame, the single frame is divided into at least three sub-frames, two or more emitting devices are sequentially driven for each sub-frame of the single frame, and one of the two or more of the emitting devices is driven again in at least one remaining sub-frame, or at least two of the two or more emitting devices are concurently driven in at least one remaining sub-frame.

5. The pixel circuit of a display device according to claim 4, wherein the at least one remaining sub-frame is arbitrarily selected from a plurality of sub-frames.

6. The pixel circuit of a display device according to claim 1, wherein the emitting devices are selected from a group consisting of a field emission display device, an organic electroluminescence device, or a liquid crystal display device.

7. The pixel circuit of a display device according to claim 1, wherein the the sequential controller includes a first electrode coupled to the driving device, and a second electrode connected to one of the at least two emitting devices.

8. The pixel circuit of a display device according to claim 7, wherein the sequential control means includes at least one switching device.

9. A pixel circuit of a display device comprising:
red, green and blue electroluminescence (EL) devices;
a driving device coupled to the red, green and blue EL devices for transmitting driving signals to the red, green and blue EL devices;
a sequential control means coupled to the red, green and blue EL devices for sequentially controlling emission of the red, green and blue EL devices for a certain period of time in a certain section; and
a sequential control part for transmitting switching signals to the sequential control means for a certain period of time in a certain section,
wherein the sequential control means controls emission of any one of the red, green and blue EL devices for the certain period of time in the certain section associated with a data charging period and an emission period.

10. The pixel circuit of a display device according to claim 9, wherein the sequential control means sequentially controls at least two of the red, green and blue EL devices, wherein the EL devices are driven only during the emission period by dividing the certain period of time in the certain section into the data charging period and the emission period.

11. The pixel circuit of a display device according to claim 10, wherein the certain section is a single frame, the certain period of time is a time period of a sub-frame of the single frame, the single frame is divided into at least two sub-frames, and one or more of the red, green and blue EL devices are sequentially driven during their respective sub-frames.

12. The pixel circuit of a display device according to claim 10, wherein the certain section is a single frame, the certain period of time is a time period of a sub-frame of the single frame, the single frame is divided into at least three sub-frames, two or more of the red, green and blue EL devices are sequentially driven during their respective sub-frames of the single frame, and one of the two or more of the EL devices is driven again in at least one remaining sub-frame, or at least two of the two or more EL devices are concurrently driven in the at least one remaining sub-frame.

13. The pixel circuit of a display device according to claim 12, wherein the at least one remaining sub-frame is arbitrarily selected from a plurality of sub-frames.

14. A method for driving a pixel circuit of a display device associated with a plurality of gate lines and a plurality of data lines, the method comprising:
sequentially applying scan signals via the gate lines and sequentially applying one or more of data signals through the data lines, the scan and data signals being concurrently applied during a certain period of time in a certain section;
applying an off signal to a sequential control means for blocking flow of the data signals to electroluminescence during storing of the data signals and
applying an on signal to the sequential control means associated with the data signals for causing emission of the EL devices responsive to the data signals being stored.

15. The method for driving a pixel circuit of a display device according to claim 14, wherein the certain section is a single frame, the certain period of time is a time period of a sub-frame of the single frame, the single frame is divided into at least two sub-frames, and one or more of the EL devices are sequentially driven during their respective sub-frames.

16. The method for driving a pixel circuit of a display device according to claim 14, wherein the certain section is a single frame, the certain period of time is a time period of a sub-frame of the single frame, the single frame is divided into at least three sub-frames, at least two of the red, green and blue EL devices are sequentially driven during their respective sub-frames of the single frame, and one of the two or more of the EL devices are driven again in at least one remaining sub-frame, or at least two of the two or more EL devices are concurrently driven in the at least one remaining sub-frame.

17. The method for driving a pixel circuit of a display device according to claim 16, wherein at least one remaining sub-frame is arbitrarily selected from a plurality of sub-frames.
